(19) United States
(12) Patent Application Publication
(10) Pub. No.: US 2023/0339646 A1
(43) Pub. Date: Oct. 26, 2023

(54) CONTAINER FOR LIQUID CONTAINING FOOD PRODUCTS

(71) Applicant: Stora Enso OYJ, Helsinki (FI)

(72) Inventors: Ville Ribu, Lappeenranta (FI); Nina Miikki, Imatra (FI); Mari Hiltunen, Imatra (FI); Juha Varis, Lappeenranta (FI); Panu Tanninen, Rauha (FI); Mika Kainusalmi, Savitaipale (FI)

(73) Assignee: Stora Enso OYJ, Helsinki (FI)

(21) Appl. No.: 17/997,842

(22) PCT Filed: May 4, 2021
(86) PCT No.: PCT/IB2021/053699

§ 371 Date: Nov. 3, 2022

(30) Foreign Application Priority Data
May 4, 2020 (SE) 2050511-1

(51) Int. Cl. B65D 1/44; B65D 1/34; B65D 81/34; B31B 50/59; B31B 50/88

(52) U.S. Cl. CPC B65D 1/44; B65D 1/34; B65D 81/3453; B31B 50/592; B31B 50/88; B31B 2110/35

(57) ABSTRACT

The present invention relates to a container for liquid containing food products, manufactured by press forming of a polymer coated fiber based substrate, said container comprising a bottom portion, a sidewall portion and a top flange portion, wherein said press forming has resulted in the formation a plurality of creases extending in a direction from the bottom portion to the top flange portion and further across the top flange portion. The container comprises an indentation pattern (130, 140, 150, 160, 170, 180, 190a, 190b, 200) formed at a creased inner surface of said sidewall portion and/or at a creased top surface of said top flange portion, said indentation pattern preventing migration of liquid from a liquid containing food product in the container along said creases. The invention relates also to a method for manufacturing such container.

### TECHNICAL FIELD

The present disclosure relates to containers for liquid containing food products. More specifically, the present disclosure relates to containers manufactured by press forming of a polymer coated fiber based substrate. The present invention further relates to methods for manufacturing a container for liquid containing food products, comprising press forming of a polymer coated fiber based substrate.

### BACKGROUND

Coating of paper and paperboard with plastics is often employed to combine the mechanical properties of the paperboard with the barrier and sealing properties of a plastic film. Paperboard provided with even a relatively small amount of a suitable plastic material can provide the properties needed to make the paperboard suitable for many demanding applications, for example as liquid packaging board.

The basic principle of the press forming of a polymer coated fiber based substrate to form a container, e.g. a tray, is to place a pre-cut and creased substrate blank between heated male and female molds that are pressed together to form a container of a desired shape. The blank is typically die cut so that the longer side of the blank is parallel to the machine direction (MD) of the substrate to give the finished container more rigidity. The folding of the corners of the container is controlled with the blank holding force applied by a rim tool. The male mold is held at the bottom end of the stroke for a set time while the polymer coating softens, and creases in the corners of the container are sealed together. Simultaneously, the top flange of the container is flattened by a larger force also applied by the rim tool. Finally, the formed container is removed, and a new substrate blank can be fed into the press. The finished container achieves its final rigidity when it cools down.

Press forming of deeper containers from paperboard utilizes creases to achieve the desired container shape. The creases are used to guide the folding in the container corners when the blank slides into the mold cavity. During the folding process, creasing lines with plastic deformation allow the blank to fold accurately and easily without cracking of the board structure.

When the finished container has been filled with a liquid containing food product, the container is typically provided with a lid which is sealed to the top flange of the container. Sealing can be achieved by means of an adhesive applied to the top flange and or lid, or by heat sealing of the polymer coated top flange to the lid.

When liquid containing food products are packaged, some of the ingredients of the product may spread or splash on the surfaces of the package for which they are not desired. This is most likely to take place in filling and baking phases of the packaging chain. Oil or grease has also a tendency to rise/climb along the wall of the packages. Especially oil and grease-like food ingredients cause problems in the closure of packages where two surfaces are glued or sealed together.

Oil or grease can rise/climb along the wall of the packages due to the capillary phenomenon, as presented in FIG. 1. This is particularly emphasized in the walls or corners of the packages with folds or wrinkles. Some manufacturing methods of the packages cause folds and wrinkles, which cannot be avoided. A typical example of such package is press formed paperboard tray, which has a set of creases in each corner that are used to control the blank forming/folding in package production. The blank is folded regularly and the polymer coating of the paperboard seals the adjacent creases together during the press-forming process. Even though the press forming molding tools smoothen the paperboard surface to a large extent, some folds or similar shapes still remain.

Thus, there remains a need for improved solutions for containers for liquid containing food products.

### SUMMARY OF THE INVENTION

It is an object of the present disclosure to alleviate at least some of the problems with liquid spreading or migration in containers for liquid containing food products.

It is a further object of the present disclosure to provide a container manufactured by press forming of a polymer coated fiber based substrate in which the spreading or migration of liquid from a liquid containing food product to a sealing surface of the container is prevented or reduced.

It is a further object of the present disclosure, to provide a press formed container in which the spreading or migration of liquid from a liquid containing food product to a sealing surface of the container is prevented or reduced, wherein the container can be manufactured in an existing press forming equipment with only minor modifications.

The above mentioned objects, as well as other objects as will be realized by the skilled person in the light of the present disclosure are achieved by the various aspects of the present disclosure.

According to a first aspect illustrated herein, there is provided a container for liquid containing food products, manufactured by press forming of a polymer coated fiber based substrate,
said container comprising a bottom portion, a sidewall portion, a top flange portion, and a plurality of creases extending in a direction from the bottom portion to the top flange portion and further across the top flange portion,
wherein the container further comprises an indentation pattern formed at a creased inner surface of said sidewall portion (i.e. at the area comprising creases, such as the area at the corners of a press formed tray container) and/or at a creased top surface of said top flange portion, said indentation pattern preventing migration of liquid from a liquid containing food product in the container along said creases.

A fiber based substrate in the context of the present disclosure refers to a sheet-like material substantially made up of a fibrous material. Important examples of fiber based materials include, but are not limited to, paper and paperboard. In some preferred embodiments, the fiber based substrate is paperboard.

Paper generally refers to a material manufactured in thin sheets from the pulp of wood or other fibrous substances comprising cellulose fibers, used for writing, drawing, or printing on, or as packaging material.

Paperboard generally refers to strong, thick paper or cardboard comprising cellulose fibers used for boxes and other types of packaging. Paperboard can either be bleached or unbleached, coated or uncoated, and produced in a variety of thicknesses, depending on the end use requirements.

In some embodiments, the fiber based substrate, e.g. paper or paperboard, used in the container has a basis weight in the range of 20-500 g/m², preferably in the range of 80-400 g/m².

The fiber based substrate is polymer coated. The polymer coating of the polymer coated fiber based substrate may comprise any of the polymers commonly used in paper or paperboard based packaging materials in general or polymers used in liquid packaging board in particular. Examples include polyethylene (PE), polyethylene terephthalate (PET), polypropylene (PP) and polylactic acid (PLA). Polyethylenes, especially low density polyethylene (LDPE) and high density polyethylene (HDPE), are also examples of polymers used in containers for liquid containing food products.

The polymer coating preferably comprises a heat sealable polymer. Using a heat sealable polymer allows the surface of the polymer coated to adhere to itself in pleats, folds or creases formed during press forming of the substrate. This adhesion improves the structural rigidity of the formed container. The heat sealable polymer may also fill and seal the pleats, folds or creases to provide a smooth and impervious container surface. Furthermore, using a heat sealable polymer allows for efficient sealing of the container by heat sealing of a lid or sealing film to the top flange of the container.

The polymer coating preferably comprises a thermoplastic polymer. In some embodiments, the polymer coating comprises a polyolefin. Thermoplastic polymers, e.g. polyolefins are useful since they provide good heat sealing properties and can be conveniently processed by extrusion coating techniques to form very thin and homogenous films with good liquid barrier properties. In some embodiments, the polymer layer comprises a polypropylene or a polyethylene. In some embodiments, the polymer layer comprises a polyethylene, such as LDPE or HDPE.

The basis weight of the polymer layer is preferably less than 60 g/m² and more preferably less than 50 g/m². In order to achieve a continuous and substantially defect free film, a basis weight of the polymer layer of at least 8 g/m², preferably at least 12 g/m² is typically required. In some embodiments, the basis weight of the polymer layer is in the range of 8-50 g/m², preferably in the range of 12-50 g/m².

The container may be any container manufactured by press forming of a polymer coated fiber based substrate, wherein said press forming results in the formation a plurality of creases extending in a direction from the bottom portion to the top flange portion and further across the top flange portion of the container. Non-limiting examples of such containers include press formed trays, plates, bowls and cups, having substantially square (e.g. quadratic or rectangular) or rounded square, substantially polygonal (e.g. hexagonal) or rounded polygonal, or substantially round (e.g. circular or elliptic) geometry.

The containers may be used, among other purposes, for storage and transport of fresh or frozen food. In some embodiments, the containers may also be used for conventional or microwave heating of food.

The container comprises a bottom portion, a sidewall portion and a top flange portion extending from the sidewall portion. The creases are mainly formed at a curved section of the sidewall portion and top flange portion.

The container comprises an indentation pattern formed at a creased inner surface of said sidewall portion and/or at a creased top surface of said top flange portion. The indentation pattern prevents migration of liquid from a liquid containing food product in the container along said creases. Preferably, the indentation pattern comprises one or more grooves formed at an inner surface of the sidewall portion and/or at a top surface of the top flange portion, said grooves extending substantially transversely across the creases formed in the press forming operation. The grooves interrupt the creases, thereby preventing migration of liquid from a liquid containing food product in the container along said creases. This way, the spreading or migration of liquid from a liquid containing food product to a sealing surface of the container can be prevented or reduced.

The indentation pattern typically comprises one or more indentations on the creased inner surface of the container. The indentations are typically formed by mechanical modification, e.g. molding or debossing, of the surface of the substrate during or after press forming of the polymer coated fiber based substrate. The indentations are formed in such a way that the polymer coating is not pierced/ruptured during manufacturing, that is, the sealing/barrier function of the polymer coating is intact also after forming the indentations.

The indentations may for example have a square, U-shaped or V-shaped cross section.

The indentations preferably have a width and depth such that they will interact with the transport of liquids on the container surface, and in the creases in particular. In some embodiments, the indentations have a width in the range of 0.1-1 mm, preferably in the range of 0.3-0.8 mm.

In some embodiments, the indentations have a depth in the range of 0.05-1 mm, preferably in the range of 0.1-0.5 mm.

The indentations are preferably spaced apart such that they will interact with the transport of liquids on the container surface, and in the creases in particular. In some embodiments, the distance between two adjacent indentations is in the range of 0.5-5 mm, preferably in the range of 1-3 mm.

Indentations formed at an inner surface of the sidewall can prevent liquid content such as oil, grease and/or water from spreading up to the top flange portion. This can help to prevent adhesion problems due to contamination of the top flange surface when a lid is heat sealed or glued onto the container. The indentations are preferably positioned on the creased inner surface of the container such that liquid transport from the bottom portion of the container towards the top flange portion of the container is prevented. Thus, in some embodiments at least one of said indentations is positioned at the topmost half of the sidewall portion so as to be able to prevent liquid spreading when the container has been filled with a liquid containing food product.

The indentations may also be positioned on the creased surface of the top flange portion of the container such that liquid transport or spreading on the top flange portion of the container is prevented. This can help to minimize contamination of the top flange surface, thereby preventing adhesion problems when a lid is to be heat sealed or glued onto the container. Thus, in some embodiments at least one of said indentations is positioned at a top surface of the top flange portion. Preferably, at least one of the indentations is positioned at an innermost half of the top flange portion, so as to be able to prevent liquid spreading when the container has been filled with a liquid containing food product.

The indentation pattern can be provided in many different forms. For example, the indentation pattern can comprise a pattern of discrete indentations interrupting the crease pattern on the inner surface of the container, or it can comprise one or more grooves traversing the creases and causing transport of liquids away from the creases.

The discrete indentations may for example be in the form of dots or short grooves. In some embodiments, the indentation pattern comprises a pattern of discrete indentations having a length of less than 10 mm, preferably less than 5 mm.

In some embodiments, the indentation pattern comprises an indentation in the form of a groove traversing said creases.

In some embodiments, the grooves have a width in the range of 0.1-1 mm, preferably in the range of 0.3-0.8 mm. A groove width in the said ranges has been found to provide better capillary action, i.e. more efficient transport of liquids away from the creases, as compared to wider or smaller grooves.

In some embodiments, the grooves have a depth in the range of 0.1-1 mm, preferably in the range of 0.1-0.5 mm. A groove depth in the said ranges has been found to provide better capillary action, i.e. more efficient transport of liquids away from the creases, as compared to wider or smaller grooves.

In some embodiments, the indentation pattern comprises at least two, preferably at least three, and more preferably at least five substantially parallel grooves. Having several grooves in parallel improves transport of liquids away from the creases, since liquid which manages to pass the first groove may be caught in the second groove, etc.

The grooves are preferably spaced apart such that they will interact with the transport of liquids on the container surface, and in the creases in particular. In some embodiments, the distance between two adjacent grooves is in the range of 0.5-5 mm, preferably in the range of 1-3 mm. A distance between two adjacent grooves in the said ranges has been found to enhance the effect of the grooves as compared to grooves arranged at smaller distances.

The grooves may preferably be designed to be as long as possible in order to maximize the volume of liquid they can aspirate. In some embodiments, at least one of said grooves extends around the entire sidewall portion of the container.

In some embodiments, at least one of said grooves extends around the entire top flange portion.

In some embodiments, the indentation pattern is formed during or after press forming of the polymer coated fiber based substrate.

According to a second aspect illustrated herein, there is provided a method for manufacturing a container for liquid containing food products, comprising the steps:
a) press forming a polymer coated fiber based substrate to obtain a container comprising a bottom portion, a sidewall portion and a top flange portion, wherein said press forming results in the formation a plurality of creases extending in a direction from the bottom portion to the top flange portion and further across the top flange portion; and
b) forming an indentation pattern at a creased inner surface of said sidewall portion and/or at a creased top surface of said top flange portion, said indentation pattern preventing migration of liquid from a liquid containing food product in the container along said creases.

The indentations are typically formed by mechanical modification, e.g. molding or debossing, of the surface of the substrate during or after press forming of the polymer coated fiber based substrate.

In some embodiments, the formation of the indentation pattern in step b) is performed simultaneously with the press forming in step a).

In some embodiments, the formation of the indentation pattern in step b) is performed as a separate step after the press forming in step a).

The Indentation pattern formed in the method according to the second aspect may be further defined as described above with reference to the first aspect.

### BRIEF DESCRIPTION OF THE DRAWINGS

FIG. 1 depicts a prior art press formed container in the form of a rectangular tray having rounded corners.

FIG. 2a-2c depict a corner section with discrete indentations according to embodiments of the invention.

FIG. 3a-3c depict a corner section with indentations in the form of grooves according to embodiments of the invention.

FIG. 4a-4b depict a corner section with indentations in the form of grooves according to embodiments of the invention.

FIG. 5 is a diagram of liquid rise times for different embodiments of the invention.

### DETAILED DESCRIPTION OF PREFERRED EMBODIMENTS

The invention will now be described more in detail with reference to specific embodiments, wherein the container is in the form of a rectangular tray having rounded corners. Alternative embodiments of the tray may be circular, or may have a different number of sidewalls, such as a pentagonal, hexagonal or octagonal tray.

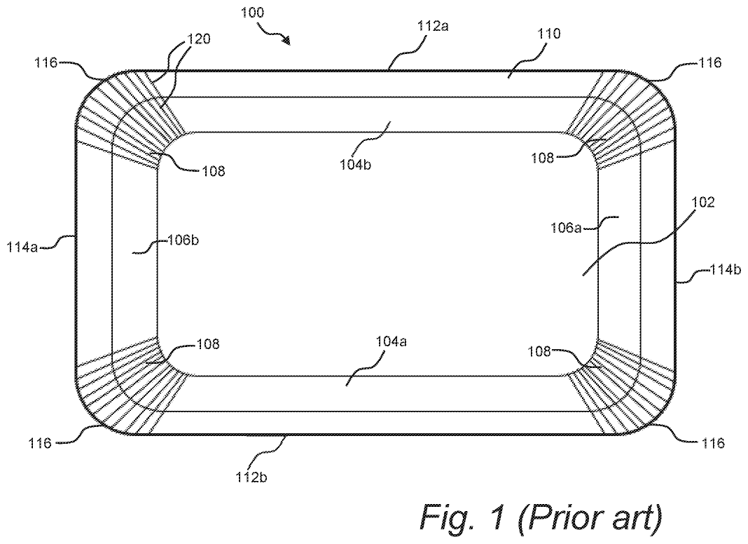

FIG. 1 depicts a prior art press formed container, in the form of a tray 100. The tray 100 is rectangular in shape, has a bottom portion 102, a first and second major sidewall 104a, 104b and a first and second minor sidewall 106a, 106b. In this embodiment, each sidewall is joined to another by a corner 108 that is generally pleated, or folded, as shown in FIG. 1.

The tray 100 is made from fiber based substrate material, typically a paperboard or a paperboard substitute, such as a bleached, unbleached, or recycled cellulose pulp molded fiber matrix. The fiber based substrate is coated, at least on the surface of the substrate which will form the inside of the container, with a heat sealable thermoplastic polymer. In alternate embodiments, the substrate may further include additional or different materials to form the tray 100, such as metal foil, paper, plastic, and so forth.

The tray body and top flange are formed from a single piece of substrate material. Within the context of this document, the phrase a “single piece of material” includes a single piece of material that comprises a single layer or multiple layers of the same material or multiple layers of different materials. These multi-layered materials could include, for example, layers of two or more paper and/or paperboard substrates completely bonded together and/or partially bonded together, such as a corrugated board material, with or without any other layer or layers of any other materials such as metal, foil, plastic, and so forth. Thus, laminates formed from two or more differing types of material are nonetheless encompassed by the phrase a “single piece of material”.

As mentioned, the tray 100 has a top flange 110 protruding outwardly from the sidewalls to mate with a lid or sealing film. Generally, when the material is formed into the flange, no portion of the flange extends into the interior of the tray. Rather, the flange 110 protrudes outwardly from the tray sidewalls as shown in, for example, FIG. 1. Alternative embodiments may have the flange extending at a different angle from the sidewalls, such as at a forty-five degree angle to or flush with the sidewalls.

In the rectangular tray 100 depicted in FIG. 1, the top flange 110 comprises major sidewall flanges 112a, 112b, minor sidewall flanges 114a, 114b, and corner flanges 116. The term corner flange refers to those portions of the top flange that extend radially outwardly from each corner 108 of the tray 100, while the term sidewall flange refers to the portions of the top flange extending outwardly from each tray sidewall. It should be understood that these terms merely refer to different portions of what is generally a unitary flange. It should be further understood that the press formed top flange 110 and tray 100 are typically formed from a continuous piece of substrate material.

FIG. 1 shows creases 120 inherently formed by folds and pleats in a press formed tray that result in an uneven surface of the corners 108 and corner flanges 116 of the tray 100. The corners 108 of the tray, 100 and thus the corner flanges 116, are pleated or folded as a byproduct of being press formed, whereas the sidewalls and sidewall flanges are smooth. The pleating or folding of material to form a corner flange typically results in irregular or nonplanar upper and lower surfaces of the corners 108 and corner flanges 116. The folds and pleats result in the formation a plurality of creases 120 extending substantially radially in a direction from a bottom portion 102 of the container to the top flange 110 and further across the top flange. As layers of material often overlap at each corner, the corners 108 typically have a greater cross-sectional thickness than the sidewalls. The same is true for the corner flanges 116 when compared to the sidewall flanges.

When liquid containing food products are packaged, some of the ingredients of the product may spread or splash on the surfaces of the package for which they are not desired. This is most likely to take place in filling and baking phases of the packaging chain. Oil or grease has also a tendency to rise/climb along the wall of the packages. Especially oil and grease-like food ingredients cause problems in the closure of packages when a lid or sealing film is glued or heat sealed to the top flange.

The uneven surfaces make it difficult to achieve a hermetic seal around, for example, the corners of the top flange 110. Possible oil or grease contamination of the top flange surfaces makes sealing even more difficult and unpredictable.

Oil or grease can rise/climb along the wall of the packages due to the capillary phenomenon. This is particularly emphasized in the walls or corners of the packages with creases extending radially in a direction from a bottom portion of the container to the top flange 110 and further across the top flange.

The irregularities or creases created within the pleated corners and corner flanges are easily seen on the press formed tray. The creases 120 may be of varying widths, depths, and so forth. Each tray is unique in its irregularities.

The inventive containers comprise an indentation pattern formed at a creased inner surface of said sidewall portion and/or at a creased top surface of said top flange portion. The indentation pattern prevents migration of liquid from a liquid containing food product in the container along said creases.

The indentation pattern typically comprises one or more indentations on the creased inner surface of the container. The indentations are typically formed by mechanical modification, e.g. molding or debossing, of the surface of the substrate during or after press forming of the polymer coated fiber based substrate.

The indentation pattern can be provided in many different forms. For example, the indentation pattern can comprise a pattern of discrete indentations interrupting the crease pattern on the inner surface of the container, or it can comprise one or more grooves traversing the creases and causing transport of liquids away from the creases.

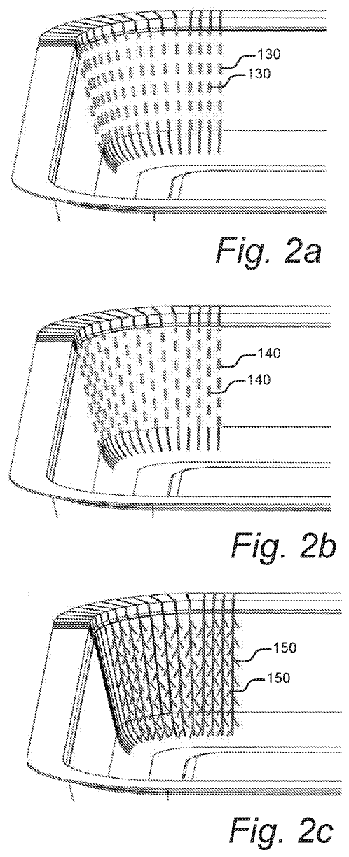

FIG. 2a shows an embodiment of the invention, where the indentation pattern is in the form of a pattern of discrete indentations. The discrete indentations are in the form of short grooves 130 arranged in parallel lines from the bottom to the top of the sidewall portion, parallel to the creases. Each discrete indentation has a length of about 3 mm, a width of about 0.5 mm, and a depth of about 0.1 mm. The distance between two adjacent indentations is about 2 mm.

FIG. 2b shows another embodiment of the invention, where the indentation pattern is in the form of pattern of discrete indentations. The pattern is similar to the pattern in FIG. 2a, with the difference that the discrete indentations, in the form of short grooves 140, of adjacent parallel lines are displaced. The discrete indentations are in the form of short grooves, each having a length of about 3 mm, a width of about 0.5 mm, and a depth of about 0.1 mm. The distance between two adjacent indentations is about 2 mm.

FIG. 2c shows another embodiment of the invention, where the indentation pattern is in the form of pattern of discrete indentations. The pattern is similar to the pattern in FIG. 2b, with the difference that the discrete indentations, in the form of short grooves 150, are tilted at an angle of about 45 degrees in relation to the parallel lines. The discrete indentations are in the form of short grooves, each having a length of about 3 mm, a width of about 0.5 mm, and a depth of about 0.1 mm. The distance between two adjacent indentations is about 2 mm.

In some embodiments of the inventive containers, one or more grooves are formed at an inner surface of the sidewall portion and/or at a top surface of the top flange portion, said grooves extending substantially transversely across the creases formed in the press forming operation. The grooves interrupt the creases, thereby preventing migration of liquid from a liquid containing food product in the container along said creases. This way, the spreading or migration of liquid from a liquid containing food product to a sealing surface of the container can be prevented or reduced.

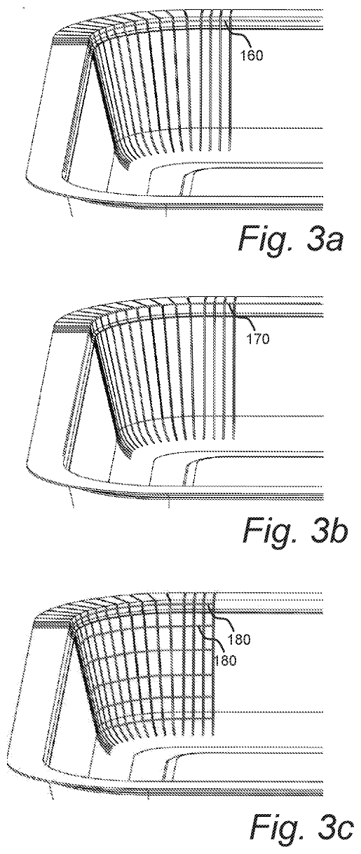

FIG. 3a shows an embodiment of the invention, where the indentation pattern is in the form of a groove 160 extending transversely across the creases in the creased inner surface near the top of the sidewall portion. The groove has a length of about 50 mm, a width of about 0.7 mm, and a depth of about 0.2 mm.

FIG. 3b shows an embodiment of the invention, where the indentation pattern is in the form of a groove 170 extending transversely across the creases in the creased top surface of the top flange portion. The groove has a length of about 50 mm, a width of about 0.7 mm, and a depth of about 0.2 mm.

FIG. 3c shows an embodiment of the invention, where the indentation pattern is in the form of a plurality of parallel grooves 180 extending transversely across the creases in the creased inner surface of the sidewall portion. The indentation pattern comprises six parallel grooves distributed from the bottom to the top of the sidewall portion, perpendicular to the creases. The grooves have a length of about 50 mm, a width of about 0.7 mm, and a depth of about 0.2 mm. The distance between two adjacent grooves is about 5 mm.

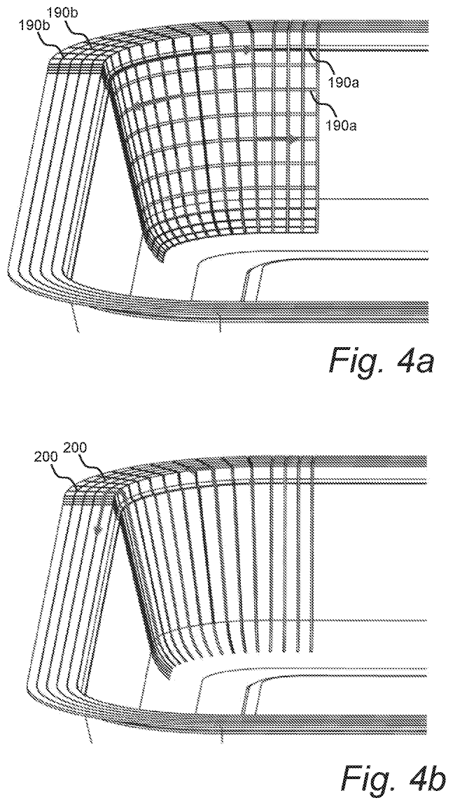

FIG. 4a shows an embodiment of the invention, where a plurality of grooves 190a is formed at an inner surface of a sidewall portion, and a plurality of grooves 190b is formed at the top surface of the top flange portion. The grooves have a width of about 0.7 mm and a depth of about 0.2 mm. The distance between two adjacent grooves is about 5 mm at the inner surface of the sidewall portion and about 2 mm at the top surface of the top flange portion. The grooves formed at the top surface of the top flange portion extend in parallel around the entire top flange portion of the container. The plurality of grooves prevents the spreading or migration of liquid from a liquid containing food product inside the container across the sealing surface of the top flange. The grooves formed at the inner surface of the sidewall portion extend in parallel around the entire sidewall portion of the container. The plurality of grooves prevents the spreading or migration of liquid from a liquid containing food product inside the container up towards the top flange. FIG. 4b shows an embodiment of the invention, where a plurality of grooves 200 is formed at the top surface of the top flange portion only.

The grooves extend in parallel around the entire top flange portion of the container. The grooves have a width of about 0.7 mm and a depth of about 0.2 mm. The distance between two adjacent grooves is about 2 mm. The plurality of grooves prevents the spreading or migration of liquid from a liquid containing food product inside the container across the sealing surface of the top flange. Droplets of liquid accidentally spilled on the top flange may also be contained in an area delimited by the grooves, and thereby prevented from spreading further over the top flange surface.

The indentation pattern, or grooves, are preferably formed by mechanical modification, e.g. molding or debossing, of the surface of the substrate by pressing it with a set of tools used in tray pressing. A negative of the desired pattern is integrated to the tool surface. The patterning tools (in micro- and macroscale) can be manufactured with various methods, including precision machining, electro erosion, laser engraving, etching, and 3D-printing. The transferability of the pattern can be adjusted by pressing force and tool temperatures. The mechanical surface modification can be done in conjunction with the actual press forming process or as a separate process cycle. The patterning method can advantageously be introduced into an existing converting machine by replacement of the forming tool.

While the invention has been described with reference to various exemplary embodiments, it will be understood by those skilled in the art that various changes may be made and equivalents may be substituted for elements thereof without departing from the scope of the invention.

In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLE

Containers in the form of a rectangular trays having rounded corners (GN¼ trays) were prepared from polyethylene terephthalate (PET) coated paperboard by press forming. Press forming resulted in the formation of a set of creases at each corner of the tray. Different indentations patterns were imprinted in the creased inside surface of the tray using a negative of the desired pattern is integrated in the press forming tool surface. In one case, the pattern was instead imprinted on the finished tray using a sheet metal beading machine. A conventional unimprinted tray was used as reference.

### Sample 1:

Indentation pattern as described with reference to FIG. 2a imprinted in the press forming tool. Discrete indentations with regular intervals in parallel lines.

Sample 2:

Indentation pattern as described with reference to FIG. 2b imprinted in the press forming tool. Discrete indentations with regular intervals in parallel lines. Discrete indentations of adjacent parallel lines are displaced.

Sample 3:

Indentation pattern as described with reference to FIG. 2c imprinted in the press forming tool. Discrete indentations with regular intervals in parallel lines. Discrete indentations of adjacent parallel lines are displaced. The discrete indentations are tilted at an angle of about 45 degrees in relation to the parallel lines.

Sample 4:

Indentation pattern as described with reference to FIG. 3c imprinted in the press forming tool. The indentation pattern comprises six parallel grooves distributed from the bottom to the top of the sidewall portion, perpendicular to the creases.

Sample 5:

Same as Sample 4 but imprinted on the finished tray using a sheet metal beading machine.

Sample 6:

A conventional unimprinted tray as described with reference to FIG. 1 was used as reference.

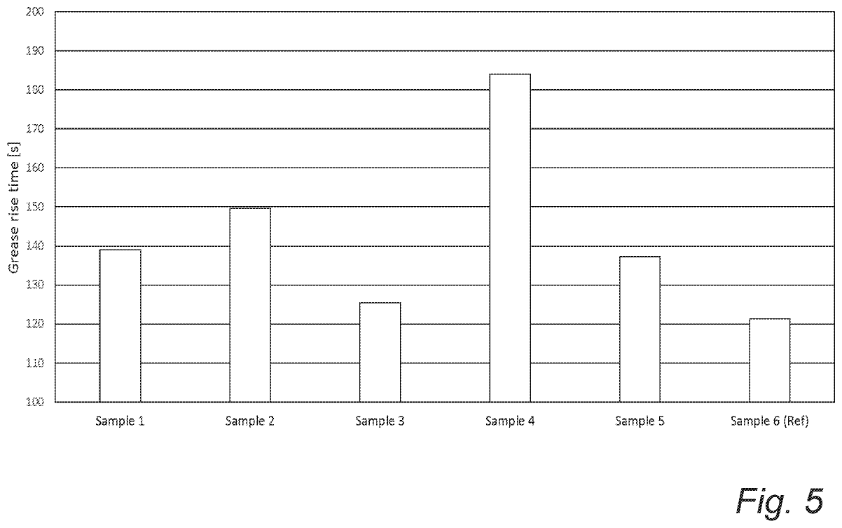

Rise time was evaluated by pouring 250 ml of a test liquid (Caj P original barbeque rapeseed oil) into the bottom of the tray and. The pathways of the liquid rising from the bottom towards the top of the creased sidewall was observed visually and the time at which the liquid reached the flange portion was measured. The results of the measurements are presented in FIG. 5. The results show that an indentation pattern can be used to significantly reduce the liquid rising. In practice, this may allow long enough time between tray filling and sealing to achieve adequate lid sealing without problems caused by contamination of the sealing surface.

1. A container for liquid containing food products, manufactured by press forming of a polymer coated fiber based substrate, said container comprising:
a bottom portion, a sidewall portion, and a top flange portion,
wherein said press forming forms a plurality of creases extending in a direction from the bottom portion to the top flange portion and further across the top flange portion, and
wherein the container comprises an indentation pattern formed at a creased inner surface of said sidewall portion, at a creased top surface of said top flange portion, or at both, and said indentation pattern preventing migration of liquid from a liquid containing food product in the container along said creases.

2. The container according to claim 1, wherein said indentation pattern comprises one or more indentations on the creased inner surface.

3. The container according to claim 1, wherein said indentations have a width in the range of 0.1-1 mm.

4. The container according to claim 1, wherein said indentations have a depth in the range of 0.05-1 mm.

5. The container according to claim 1, wherein a distance between two adjacent indentations is in a range of 0.5-5 mm.

6. The container according to claim 1, wherein at least one of said indentations is positioned at a topmost half of the sidewall portion.

7. The container according to claim 1, wherein at least one of said indentations is positioned at a top surface of the top flange portion.

8. The container according to claim 1, wherein said indentation pattern comprises a pattern of discrete indentations having a length of less than 10 mm.

9. The container according to claim 1, wherein said indentation pattern comprises an indentation in the form of a groove traversing said creases.

10. The container according to claim 9, wherein said indentation pattern comprises at least two parallel grooves.

11. The container according to claim 9, wherein said the groove extends entirely around the sidewall portion of the container.

12. The container according to claim 9, wherein the groove extends entirely around the top flange portion.

13. The container according to claim 1 wherein said indentation pattern is formed during or after press forming of the polymer coated fiber based substrate.

14. The container according to claim 1, wherein a polymer coating of the polymer coated fiber based substrate comprises one or more of: polyethylene (PE), polyethylene terephthalate (PET), polypropylene (PP) and polylactic acid (PLA).

15. The container according to claim 1, wherein the barrier and sealing properties of the polymer coating is intact after forming of the indentation pattern.

16. A method for manufacturing a container for liquid containing food products, the method comprising the steps:
a) press forming a polymer coated fiber based substrate to obtain a container comprising a bottom portion, a sidewall portion, and a top flange portion, wherein said press forming forms a plurality of creases extending in a direction from the bottom portion to the top flange portion and further across the top flange portion; and
b) forming an indentation pattern at a creased inner surface of said sidewall portion, at a creased top surface of said top flange portion, or both
wherein said indentation pattern prevents migration of liquid from a liquid containing food product in the container along said creases.

17. The method according to claim 16, wherein the indentation pattern in step b) is formed simultaneously with the press forming in step a).

18. The method according to claim 16, wherein the indentation pattern in step b) is formed as a separate step after the press forming in step a).

19. The method according to claim 16, wherein the indentation pattern formed comprises:
a width in the range of 0.1-1 mm; or
a depth in the range of 0.05-1 mm; or
a distance between two adjacent indentations in a range of 0.5-5 mm; or
at least one of said indentations is positioned at a topmost half of the sidewall portion; or
at least one of said indentations is positioned at a top surface of the top flange portion; or
a pattern of discrete indentations having a length of less than 10 mm; or
an indentation in the form of a groove traversing said creases; or
at least two parallel grooves; or
any combination of the foregoing.
